(19) United States
(12) Patent Application Publication
(10) Pub. No.: US 2014/0238968 A1
(43) Pub. Date: Aug. 28, 2014

(54) INTELLIGENT HEATING CABLE HAVING A SMART FUNCTION AND METHOD FOR MANUFACTURING SAME

(71) Applicant: Wan-Soo Lee, Seongnam-si (KR)

(72) Inventor: Wan-Soo Lee, Seongnam-si (KR)

(21) Appl. No.: 14/343,128

(22) PCT Filed: Sep. 7, 2012
(86) PCT No.: PCT/KR2012/007243

§ 371 Date: Mar. 6, 2014

(30) Foreign Application Priority Data
Sep. 8, 2011 (KR) 10-2011-0091186

(51) Int. Cl. H05B 3/56

(52) U.S. Cl. CPC H05B 3/56
USPC 219/209; 29/611

(57) ABSTRACT

According to the present disclosure, a heating cable has a hybrid construction in which an optical cable sensor is coupled to the heating cable to achieve the function of a sensor for sensing the temperatures of both an object and the heating cable so as to provide an active heating supply source capable of adjusting the output of the heating cable in accordance with temperature variations. To this end, an intelligent heating cable of the present disclosure provides smart heating for use with a heat tracing system. The cable comprises a heating element and an insulating layer formed on an outer surface of the heating element and features an optical cable combined as a temperature sensor.

### TECHNICAL FIELD

The present disclosure in one or more embodiments relates to an intelligent heating cable providing smart heating and a method of manufacturing the same. More particularly, the present disclosure relates to an intelligent heating cable providing smart heating, wherein an optical cable sensor is embedded in a heating cable of a heat tracing system such that the heating cable has a function of sensing the temperature of the system to minutely measure the temperature of a portion difficult to sense temperature in the system and thus to properly control the output of the heating cable, thereby reducing unnecessary energy consumption or preventing damage to the heating system due to insufficient supply of heat, and a method of manufacturing the same.

### BACKGROUND

In general, a heat tracing system is used to compensate for heat loss caused from a facility or an object, such as a pipe or a tank, or to supply a uniform amount of heat to the object, thereby preventing the object from being frozen to burst or uniformly maintaining the temperature of the object. In addition, the heat tracing system prevents frost from forming on a concrete slab or to remove snow from a road or is installed as an indoor floor heating system.

In the heat tracing system, a heating cable serves to supply heat necessary for the object having the system installed. The heating cable is constructed to have a multi-layer structure including a heating element for generating heat, insulation for protecting the heat element, and an outer jacket. In the heat tracing system, the heating cable is operated based on a temperature measured from the system or the object. For example, in order to prevent a pipe or a tank from being frozen to burst, the heat tracing system is powered on to supply heat to the pipe or the tank through the heating cable when the measured temperature of the system is lower than a reference temperature used as the critical temperature at which the pipe or the tank is prevented from being frozen to burst.

When the measured temperature exceeds the reference temperature, the heat tracing system is powered off to interrupt the operation of the heating cable, thereby reducing unnecessary energy consumption. In case the heating cable is installed to maintain the temperature of the pipe or the tank, if the measured temperature exceeds the upper limit of a predetermined temperature range to maintain, the heating cable is powered off to interrupt the supply of heat. On the other hand, if the measured temperature goes below the lower limit of the temperature range, the heating cable is powered on to supply heat to the object. This operating principle of the heating cable also applies to a heating cable used to prevent frost or freezing or to heat a room.

In order to efficiently and properly operate the heating cable in the heat tracing system, the heating cable need to be suitably designed considering the heating capacity and the temperature of the system need to be accurately measured in timely manner.

A conventional heating cable includes a heating element, insulation for protecting the heating element, and an outer jacket. Power supplied to the heating cable is controlled based on changes in temperature sensed by an external temperature sensor to properly adjust the output of the heating cable. Since the temperature necessary to control the power supplied to the heating cable is measured by a temperature sensor mounted at an object, such as a tank or a pipe, the position of the sensor is critical.

In a conventional heat tracing system, a sensor for measuring the temperature of the system is usually mounted at a point representing the temperature of the system or a point where the system is exposed to the harsh conditions. The measured temperature is a reference used to control the operation of the heating cable or basic data used to check the condition of the system. For this reason, measurement of the temperature of the system is critical in efficient operation of the system and, therefore, it is reasonable and appropriate to measure temperatures of the system at various points of the system and to operate the system based thereupon.

Since, in most cases, the temperature sensor is mounted at one point, such as a point representing the temperature of an object or a point exposed to harsh conditions, the temperature sensor is unable to present the overall temperature of the object.

Although the described conventional method may provide a simple construction of the system, it does not contemplate to measure the temperature of the entire object but a single selected point which is then assumed to be the overall temperature as a basis for controlling the systems. By doing this, a simple and convenient measurement of temperature can be achieved, while the overall temperatures of the object cannot be provided. In case, however, it is necessary to control the heat supply based upon a precise measurement of the temperature of an object, conventional methods are ineffective in providing such proper control.

In case the object has an uneven temperature profile, sensors cannot be deployed at all points to measure the temperatures of the object. Consequently, it may be inefficient and improper to adjust thermal capacity of the heating cable based on the temperatures measured at limited number of points.

It costs a great deal to deploy sensors at multiple points of the heat tracing system and to measure temperatures at the points of the heat tracing system. In addition, it is highly costly for the temperature of the entire system to be accurately measured.

### DISCLOSURE

### Technical Problem

Therefore, the present disclosure has been made in an effort to effectively resolving the above-described limitations and provides a heating cable combined with an optical cable sensor. The heating cable is capable of measuring the temperature of the heating cable itself, which cannot be achieved by a conventional heating cable. Consequently, the present disclosure provides an intelligent heating cable providing smart heating and self diagnosis of a system in addition to efficient supply of heat and a method of manufacturing the same.

### SUMMARY

In accordance with some embodiments of the present disclosure, an intelligent heating cable, for use in a heat tracing system, comprises a heating element and an insulating layer formed at an outer surface of the heating element. The heating cable has a hybrid construction in which an optical cable as a sensor is combined with the heating cable.

The heating element may be any one selected from among a polymeric heating element exhibiting positive temperature coefficient of resistance (PTC) characteristics, the polymeric heating element generating heat using electrical energy, a metallic resistance alloy conductor and a copper conductor.

The polymeric heating element may contain, in a polymeric material constituting the heating element, any one selected from carbon black, metal powder, and carbon fiber, as a conductive material to exhibit electrical conductivity.

The metallic resistance alloy conductor may contain any one selected from among copper-nickel, nickel-chrome, and iron-nickel as a main ingredient.

The copper conductor may comprise any one selected from among unplated copper, tin-plated copper, silver-plated copper and nickel-plated copper.

The optical cable may be made of optical fiber, such as glass optic fiber or plastic optic fiber.

In accordance with some embodiments of the present disclosure, a method for manufacturing an intelligent heating cable comprises forming by using extrusion molding, on an outer surface of a heating element of a heating cable, insulation constructed to protect the heating cable; combining an optical cable sensor functioning as a temperature sensor on the insulated heating element; fixing the optical cable sensor to the insulated heating element through copper wire braiding or cotton braiding, and extruding an outer jacket and performing a post-treatment process.

### Advantageous Effects

According to the present disclosure as described above, an intelligent heating cable providing a smart heating is used to thereby considerably improve the energy efficiency of a heat tracing system. In addition, an unexpected serious danger, such as fire or explosion, which may be caused to the system by the heating cable during use of the heating cable, is monitored. Furthermore, change in performance of the heat tracing system, which may occur in the heating cable installed in the heat tracing system, is monitored in real time, thereby improving and guaranteeing stability of the heat tracing system.

According to the present disclosure as described above, an optical cable is used as a sensor to measure change in temperature of the heating cable and the surroundings using the optical cable in real time and to accurately monitor the change in temperature and temperature distribution over the entire area, in which the heating cable is placed. Due to such smart heating, the temperature of a portion where temperature sensing is not easy in the heat tracing system may be minutely checked to thereby efficiently supply an amount of heat necessary for a facility and reduce energy consumption.

Since change in temperature of the entire area of the heating cable is monitored in real time, the present disclosure as described above provides convenient check of the operation of the heating cable at any time. Abnormality which may occur in the system in which the heating cable is placed due to unexpected internal and external situations or a degradation phenomenon which may gradually occur over time may be observed and resolved based on change in temperature over time. Furthermore, an abnormal point is accurately checked and repaired to thereby achieve easy repair and further reduce repair costs.

The intelligent heating cable having such a self temperature measurement function according to the present disclosure has the following effects, which cannot be provided by a conventional heating cable.

1. Change in temperature and temperature distribution of the entire system can be accurately checked in real time;

2. Efficient energy saving can be achieved;

3. An abnormal point caused due to an excessive amount of heat or an insufficient amount of heat can be accurately observed; and

4. Such an abnormal point can be easily found, thereby reducing repair costs.

Meanwhile, according to the present disclosure as described above, the temperatures of a facility and the entire heating cable can be measured in real time in addition to the smart heating, thereby optimizing energy efficiency of the heat tracing system. In addition, the present disclosure as described above has the advantageous effect of monitoring whether the heat tracing system is abnormal in real time by tracing the change in temperature of the heating cable.

### DESCRIPTION OF DRAWINGS

FIG. 1 is a schematic diagram showing a construction of a heat tracing system having an intelligent heating cable providing smart heating according to at least one embodiment of the present disclosure mounted therein;

FIG. 2 is diagram showing a construction of a heating cable providing smart heating according to at least one embodiment of the present disclosure;

FIG. 3 is diagram showing the measurement results of temperature over the entire length of a heating cable using an intelligent heating cable providing smart heating according to at least one embodiment of the present disclosure;

FIGS. 4 to 6 are diagrams illustrating types of an intelligent heating cable providing smart heating according to at least one embodiment of the present disclosure; and

FIGS. 7 and 8 are schematic diagrams of measurement apparatuses used in at least one embodiment of the present disclosure.

### DESCRIPTION OF REFERENCE NUMERALS

| | |
|---|---|
| 10, 20, 30, 40, 70: Heating cables | |
| 21, 32, 41: Heating elements | 23, 33, 43: Optical cable sensors |
| 50: Temperature controlled unit | 60: Water bath |
| 80: Temperature controlled chamber | |

### DETAILED DESCRIPTION

The present disclosure provides a new heating cable having a hybrid construction in which an optical cable sensor is combined in the heating cable to measure the temperature of a system having the heating cable mounted therein using the optical cable sensor as well as to generate heat, thereby performing efficient and proper operation based on the measured temperature.

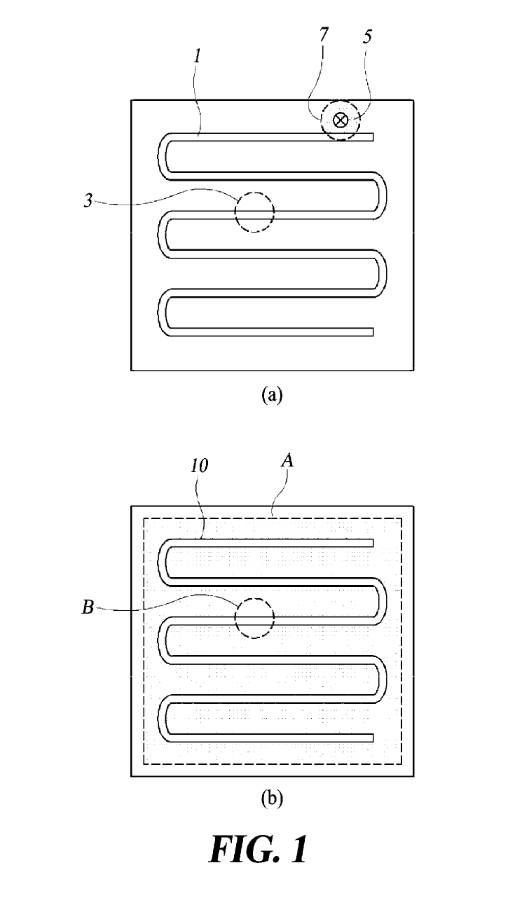

FIG. 1 is a schematic diagram showing a construction of a heat tracing system having an intelligent heating cable providing smart heating according to at least one embodiment of the present disclosure mounted therein. FIG. 1(b) is a diagram showing a construction of a heat tracing system according to at least one embodiment of the present disclosure and FIG. 1(a) is a diagram showing a construction of a conventional heat tracing system to compare with the heat tracing system according to the embodiment of the present disclosure.

As shown in FIG. 1, in a new heat tracing system, in which a heating cable according to at least one embodiment of the present disclosure is installed, the heating cable 10 itself functions as a temperature sensor. Consequently, the temperature sensor can be mounted and temperature can be measured at any point of the heating cable 10, thereby accurately locating a weak portion in the system.

Consequently, the operation of the heating cable can be controlled based on the weak portion in the system to achieve both the efficient operation and the energy saving of the system.

In FIG. 1(b), reference symbol A indicates a temperature measurement area and B indicates a weak portion in the system.

In an example of a conventional heat tracing system, as shown in FIG. 1(a), temperature is measured at a point 5 where a temperature sensor is mounted. However, this point 5 may be different from a weak portion 3. In a case in which the point 5, where the temperature sensor is mounted, is different from the weak portion 3, it is difficult to efficiently operate a heating cable 1. Reference numeral 7 indicates a temperature measurement area.

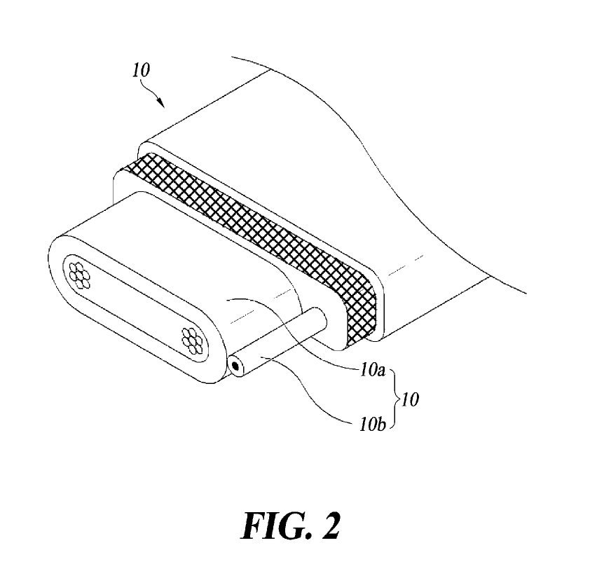

FIG. 2 is diagram showing a construction of a heating cable providing smart heating according to at least one embodiment of the present disclosure.

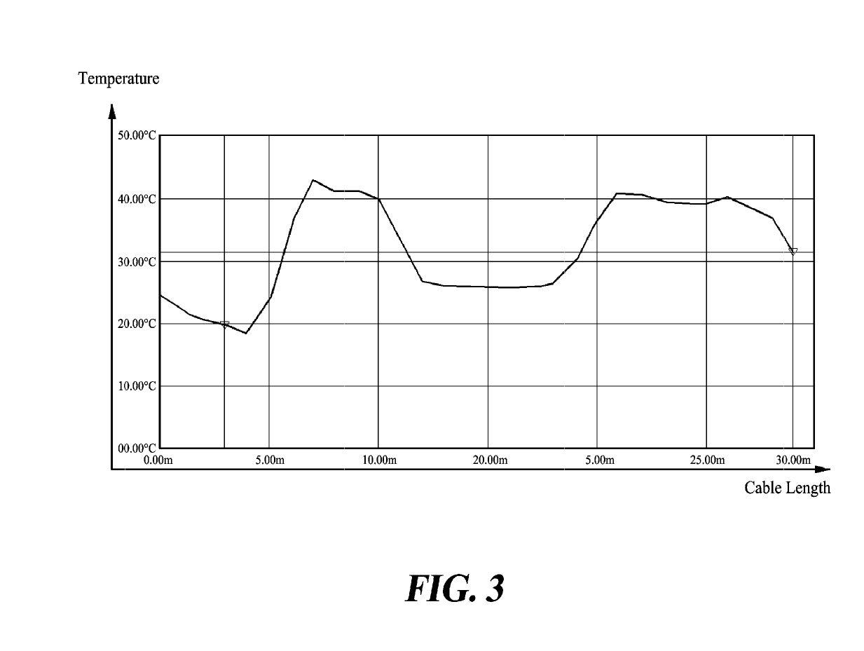

As shown in FIG. 2, the heating cable 10 providing smart heating according to the embodiment of the present disclosure has a function as a sensor for measuring temperature using change in optical signals transmitted via an optical cable 10b which is combined with a heating cable 10a. Consequently, the temperature of the entire system having the heating cable 10a embedded therein can be continuously measured in real time. A typical example of such a temperature measurement function is shown in FIG. 3.

FIG. 3 is a graph showing distribution of temperature measured using a heating cable providing smart heating according to at least one embodiment of the present disclosure.

As can be seen from FIG. 3, temperature can be measured at all points of the heating cable and thus an accurate temperature distribution profile can be obtained. Consequently, the operation of the heating cable can be properly controlled using the temperature distribution profile.

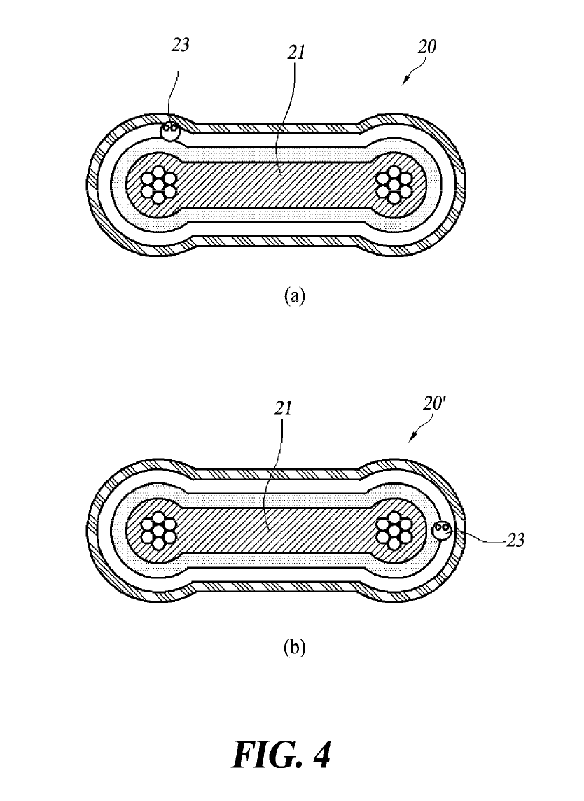

Meanwhile, FIGS. 4 to 6 are diagrams illustrating types of a heating cable providing smart heating according to at least one embodiment of the present disclosure.

FIG. 4 is a diagram illustrating intelligent heating cables using a polymeric heating element exhibiting positive temperature coefficient of resistance (PTC) characteristics.

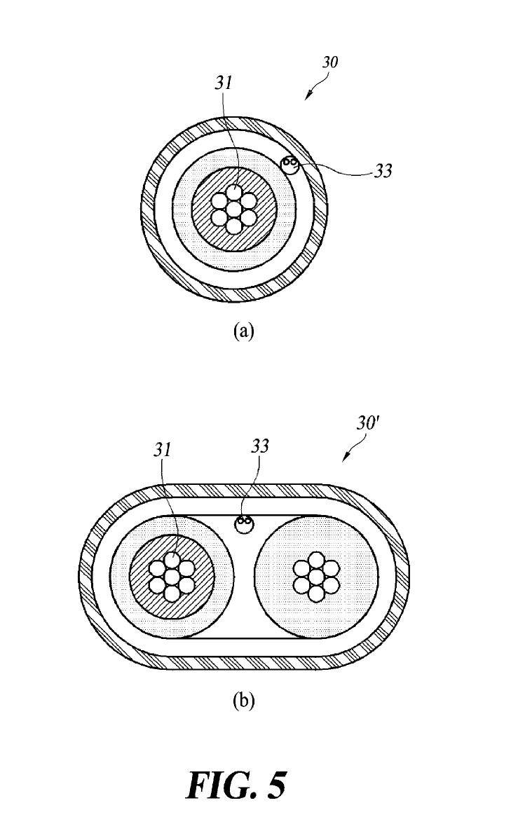

FIG. 5 is a diagram showing intelligent heating cables using a heating element made of a metallic resistance alloy conductor.

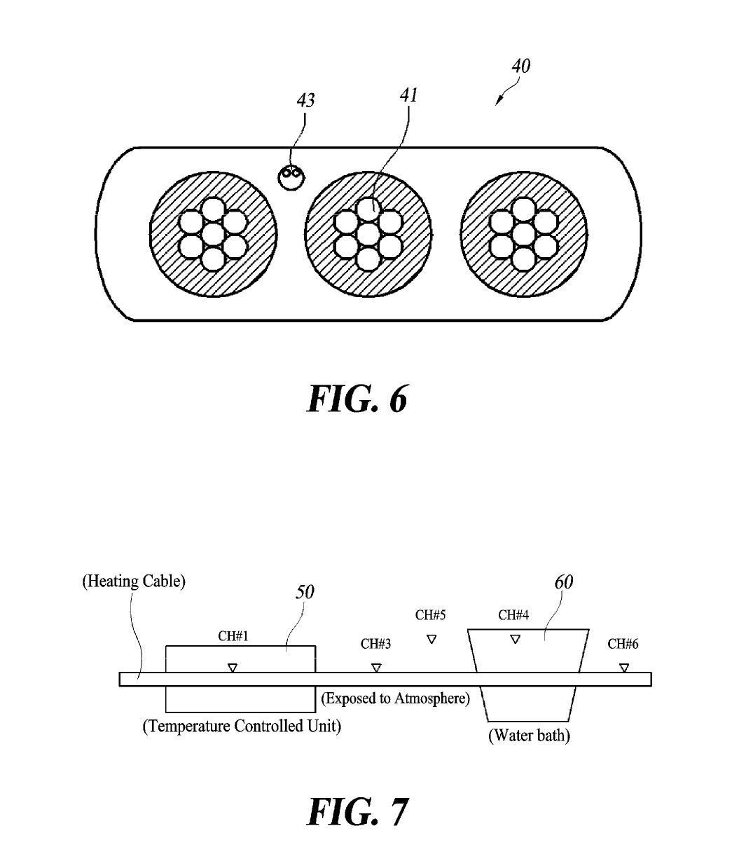

FIG. 6 is a diagram showing an intelligent heating cable using an alloy conductor or a copper conductor as a heating element.

In the heating cables 20 and 20′ providing smart heating of FIG. 4, reference numeral 21 indicates a polymeric heating element exhibiting PTC characteristics and reference numeral 23 indicates an optical cable sensor.

In the heating cables 30 and 30′ providing smart heating of FIG. 5, reference numeral 31 indicates a heating element made of a metallic resistance alloy conductor and reference numeral 33 indicates an optical cable sensor.

In the heating cable 40 providing smart heating of FIG. 6, reference numeral 41 indicates a heating element made of a metallic resistance alloy conductor or a copper conductor and reference numeral 43 indicates an optical cable sensor.

As illustrated in the above drawings, the heating cable providing smart heating according to the embodiment of the present disclosure can be formed using various heating elements, such as a polymeric heating element, a heating element made of a metallic resistance alloy conductor, and a heating element made of a copper conductor.

Hereinafter, a process of manufacturing an intelligent heating cable providing smart heating according to at least one embodiment of the present disclosure will be described.

The heating cable is manufactured through the following processes.

An insulation is formed on an outer surface of a heating element of a heating cable for protecting the heating cable by extrusion molding. The heating element used herein may include any one selected from among heating elements designed for special purposes, such as a polymeric heating element exhibiting PTC characteristics, a heating element made of a metallic resistance alloy conductor, and heating element made of a copper conductor, as illustrated above.

An optical cable is combined on the insulated heating element, the optical cable functioning as a temperature sensor. Then, the optical cable sensor is fixed to the insulated heating element through copper wire braiding or cotton braiding.

An outer jacket is extruded upon completion of the braiding and post-treatment is performed to obtain a heating cable with smart heating feature.

Examples of temperature measurement on the heating cable using the heating cable having the polymeric heating element and the metallic resistance alloy conductor as mentioned above will now be described.

### EXAMPLE 1

First, insulation was formed on a polymeric heating element exhibiting PTC characteristics by extrusion, an optical cable sensor was combined on the insulated heating element, the optical cable sensor was fixed through copper wire braiding, and an outer jacket was extruded to manufacture a test specimen of a heating cable.

The manufactured test specimen was placed in experiment facilities having different temperature zones as shown in FIG. 7 and the temperatures of the optical cable sensor were measured while changing temperatures at various portions of the test specimen and the output of the heating cable. The results are shown in Table 1 below.

TABLE 1
Changes in temperature of heating cable having polymeric heating element
exhibiting PTC characteristics

| Output (W/m) | 18.6 | Temperature | Atmospheric | | Water bath | Atmospheric |
|---|---|---|---|---|---|---|
| | | controlled unit | conditioning | | | temperature |
| Reference | 10.0 | CH#1 | CH#3 | CH#6 | CH#4 | CH#5 |
| temperature | | | | | | |
| (° C.) | | | | | | |
| Optical cable sensor | | 29.5 | 38.5 | 37.3 | 20.6 | 19.5 |
| Thermocouple | | 29.4 | 38.2 | 37.9 | 13.6 | 18.9 |
| Output (W/m) | 16.4 | Temperature | Atmospheric | | Water bath | Atmospheric |
| | | controlled unit | conditioning | | | temperature |
| Reference | 20.0 | CH#1 | CH#3 | CH#6 | CH#4 | CH#5 |
| temperature | | | | | | |
| (° C.) | | | | | | |
| Optical cable sensor | | 36.3 | 39.6 | 39.2 | 25.1 | 19.9 |
| Thermocouple | | 34.7 | 38.1 | 38.6 | 17.8 | 20.7 |
| Output (W/m) | 15.3 | Temperature | Atmospheric | | Water bath | Atmospheric |
| | | controlled unit | conditioning | | | temperature |
| Reference | 30.0 | CH#1 | CH#3 | CH#6 | CH#4 | CH#5 |
| temperature | | | | | | |
| (° C.) | | | | | | |
| Optical cable sensor | | 40.3 | 40.7 | 38.9 | 25.6 | 21.6 |
| Thermocouple | | 39.8 | 39.8 | 38.5 | 18.5 | 21.5 |
| Output (W/m) | 14.8 | Temperature | Atmospheric | | Water bath | Atmospheric |
| | | controlled unit | conditioning | | | temperature |
| Reference | 40.0 | CH#1 | CH#3 | CH#6 | CH#4 | CH#5 |
| temperature | | | | | | |
| (° C.) | | | | | | |
| Optical cable sensor | | 44.2 | 39.8 | 38.4 | 24.7 | 21.9 |
| Thermocouple | | 45.5 | 39.3 | 38.1 | 18.1 | 21.3 |
| Output (W/m) | 13.6 | Temperature | Atmospheric | | Water bath | Atmospheric |
| | | controlled unit | conditioning | | | temperature |
| Reference | 50.0 | CH#1 | CH#3 | CH#6 | CH#4 | CH#5 |
| temperature | | | | | | |
| (° C.) | | | | | | |

| | | | | | |
|---|---|---|---|---|---|
| Optical cable sensor | 52.0 | 39.3 | 39.7 | 25.1 | 22.2 |
| Thermocouple | 52.0 | 38.6 | 39.6 | 18.3 | 21.9 |

### EXAMPLE 2

Insulation was formed on a heating element made of a metallic resistance alloy conductor by extrusion, an optical cable sensor was combined on the insulated heating element, the optical cable sensor was fixed through copper wire braiding, and an outer jacket was extruded to manufacture a test specimen of a heating cable.

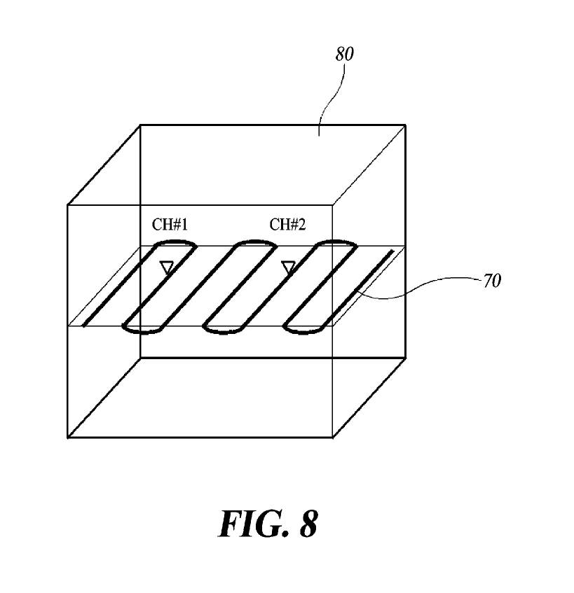

The manufactured test specimen was placed in a temperature controlled chamber having uniform air speed under a temperature atmosphere as shown in FIG. 8 and the temperatures of the optical cable sensor were measured while changing the temperature and output of the test specimen. The results are shown in Table 2 below.

TABLE 2
Changes in temperature of heating cable using metallic resistance alloy
conductor as heating element

| | | | | | | | | | | | |
|---|---|---|---|---|---|---|---|---|---|---|---|
| Reference | 10.0 | | | | | | | | | | |
| temperature (° C.) | | | | | | | | | | | |
| Output (W/m) | 0 | 20 | 25 | 30 | 35 | 40 | 45 | 50 | 55 | 60 | 70 |
| Optical cable | 10.6 | 23.7 | 27.1 | 31.5 | 34.1 | 37.3 | 41.2 | 46.9 | 48.3 | 53.3 | 59.1 |
| sensor #1 | | | | | | | | | | | |
| Optical cable | 10.5 | 23.9 | 27.0 | 31.7 | 34.2 | 37.5 | 41.5 | 46.8 | 48.2 | 53.4 | 59.2 |
| sensor #2 | | | | | | | | | | | |
| Thermocouple #1 | 10.4 | 22.8 | 26.4 | 31.0 | 33.4 | 36.3 | 40.4 | 45.8 | 47.2 | 52.1 | 58.1 |
| Thermocouple #2 | 10.4 | 22.6 | 26.4 | 30.9 | 33.3 | 36.3 | 40.3 | 45.2 | 47.0 | 50.9 | 57.3 |
| Reference | 5.0 | | | | | | | | | | |
| temperature (° C.) | | | | | | | | | | | |
| Output (W/m) | 0 | 20 | 25 | 30 | 35 | 40 | 45 | 50 | 55 | 60 | 70 |
| Optical cable | 5.5 | 19.5 | 22.8 | 26.3 | 29.8 | 33.0 | 39.0 | 41.2 | 44.4 | 49.1 | 55.1 |
| sensor #1 | | | | | | | | | | | |
| Optical cable | 5.7 | 20.2 | 23.9 | 27.5 | 31.3 | 33.9 | 40.1 | 42.3 | 45.3 | 50.4 | 56.2 |
| sensor #2 | | | | | | | | | | | |
| Thermocouple #1 | 5.4 | 18.4 | 22.0 | 25.4 | 29.2 | 32.1 | 38.1 | 40.8 | 43.9 | 48.3 | 54.0 |
| Thermocouple #2 | 5.5 | 19.6 | 23.1 | 26.9 | 30.6 | 33.2 | 39.4 | 41.6 | 44.5 | 49.6 | 55.3 |

### COMPARATIVE EXAMPLE 1

A thermocouple was attached to the surface of the test specimen of the heating cable of <Example 1> per temperature zone and temperature was measured in the same manner as in <Example 1>.

### COMPARATIVE EXAMPLE 2

A thermocouple was attached to the surface of the test specimen of the heating cable of <Example 2> and temperature was measured in the same manner as in <Example 2>.

The test specimens of the heating cables mentioned in the examples and the comparative examples were placed in a test apparatus and the temperature of the system and the output of the heating cable were measured to evaluate performance of the respective test specimens.

FIGS. 7 and 8 are schematic diagrams of measurement apparatuses used for <Example 1> and <Example 2>.

For <Example 1> and <Comparative example 1>, as shown in FIG. 7, the test apparatus has three zones having different temperature conditions, such as a temperature controlled unit 50, a zone exposed to atmosphere, and a water bath 60 containing a predetermined amount of water. The temperature controlled unit 50 is an apparatus that circulates fluid at a uniform flow speed to maintain the temperature designed for testing. In the three zones of the test apparatus, the temperature of the optical cable sensor and the temperature of the thermocouple attached to the surface of the heating cable were measured in accordance with various conditions and they were compared.

For <Example 2> and <Comparative example 2>, as shown in FIG. 8, a heating cable 70 was attached to a shelf in a zigzag pattern, the heating cable 70 was placed in a temperature controlled chamber 80 in which air is circulated at a uniform air speed, and the temperatures of the thermocouples attached to the surface 70 of the heating cable and temperatures measured by the optical cable sensor in the heating cable were compared under various conditions.

The output of the heating cable was calculated by changing voltage applied to the heating cable by using a transformer and measuring the current flowing through the heating cable.

[Measurement Results According to <Example 1>]

It can be seen that there is no difference between the measured temperature of the thermocouple mounted at the test specimen and the temperature measured by the optical cable sensor. Moreover, it is obvious that, when the temperatures of various portions of the test specimen are changed, the change in temperature of each portion is sensed with high precision by the optical cable sensor. It can be seen that distribution of change in temperature over the heating cable and the temperature of each point of the heating cable are measured with high precision by the optical cable sensor and displayed.

It can be seen that the temperature of the portion immersed in the water bath measured by the optical cable sensor is higher than that measured by the thermocouple. This is because the thermocouple measures the temperature of water in the water bath, whereas the optical cable sensor measures the temperature of the heating cable alone. This difference shows that, in actual temperature measurement, the optical cable sensor can more directly and minutely measure the temperature, and that temperatures measured depending upon the position of the sensor may be different from the actual temperatures.

[Measurement Results of <Example 2>]

It can be seen that, when comparing the measured values of the thermocouple and the optical cable sensor, changes in temperature of the heating cable caused in accordance with the change in output of the heating cable are equal to each other. In an actual situation, continuous temperature distribution appearing in the longitudinal direction of the heating cable can be seen in detail based on the measured value of the optical cable sensor. This continuous temperature distribution cannot be obtained using thermocouples.

1. An intelligent heating cable for use in a heat tracing system, the intelligent heating cable comprising:
a heating element and an insulating layer formed at an outer surface of the heating element, wherein
the heating cable has a hybrid construction in which an optical cable as a sensor is combined with the heating cable.

2. The intelligent heating cable of claim 1, wherein the heating element is any one selected from among a polymeric heating element exhibiting positive temperature coefficient of resistance (PTC) characteristics, the polymeric heating element generating heat using electrical energy, a metallic resistance alloy conductor, and a copper conductor.

3. The intelligent heating cable of claim 2, wherein the polymeric heating element contains, in a polymeric material constituting the heating element, any one selected from carbon black, metal powder, and carbon fiber, as a conductive material to exhibit electrical conductivity.

4. The intelligent heating cable of claim 2, wherein the metallic resistance alloy conductor contains any one selected from among copper-nickel, nickel-chrome, and iron-nickel as a main ingredient.

5. The intelligent heating cable of claim 2, wherein the copper conductor comprises any one selected from among unplated copper, tin-plated copper, silver-plated copper, and nickel-plated copper.

6. The intelligent heating cable of claim 1, wherein the optical cable is made of optical fiber, such as glass optic fiber or plastic optic fiber.

7. A method for manufacturing an intelligent heating cable, the method comprising:
forming by using extrusion molding, on an outer surface of a heating element of a heating cable, an insulation constructed to protect the heating cable;
combining an optical cable sensor functioning as a temperature sensor on the insulated heating element;
fixing the optical cable sensor to the insulated heating element through copper wire braiding or cotton braiding; and
extruding an outer jacket and performing a post-treatment process.
